(19) United States
(12) Patent Application Publication
(10) Pub. No.: US 2022/0258879 A1
(43) Pub. Date: Aug. 18, 2022

(54) SKEW AND LOSS DETECTION SYSTEM

(71) Applicant: Moog Wolverhampton Limited, Wolverthampton (GB)

(72) Inventor: Glynn Thomas, Penkridge (GB)

(21) Appl. No.: 17/625,077

(22) PCT Filed: Jul. 2, 2020
(86) PCT No.: PCT/EP2020/068680

§ 371 Date: Jan. 5, 2022

(30) Foreign Application Priority Data
Jul. 9, 2019 (GB) 1909825.0

(51) Int. Cl. B64D 45/00; B64C 13/34; B64C 9/22

(52) U.S. Cl. CPC B64D 45/0005; B64C 9/22; B64C 13/34

(57) ABSTRACT

A skew detection system for an aircraft flight control surface, the flight control surface being moveable relative to fixed structure of the aircraft by operation of a first gear rack driven by a first gear pinion and by operation of a second gear rack driven by a second gear pinion, the skew detection system including a first sensor arrangement and a second sensor arrangement, the first gear rack having a first set of teeth defining a plurality of first targets, the second gear rack having a second set of teeth defining a plurality of second targets, the plurality of first targets being configured to move relative to the first sensor arrangement and the plurality of second targets being configured to move relative to the second sensor arrangement, the skew detection system including a monitoring device to monitor the output from the first and second sensors and determine whether a skew condition has arisen in the flight control surface.

The present invention relates to a skew and/or loss detection system.

Aircraft wings typically include one or more actuable control surface elements. These control surface elements define control surfaces (also known as auxiliary aerofoils) which are moveable relative to the fixed wing structure in order to alter the aerodynamic characteristics of the wing. Such control surface elements include leading edge devices such as slats and trailing edge devices such as flaps.

Typically, control surface elements are actuated at either span wise end by two separate actuators. It is conceivable that if either of these two actuators malfunctions, inconsistent actuation and skew or loss of the associated control surface could occur. It is important that if skew or loss is detected, the relevant systems are shut down and the pilot of the aircraft is notified.

Various methods have been proposed in the prior art for detection of skew and/or loss of control surface elements. One such system is described in U.S. Pat. No. 5,686,907, wherein proximity targets are attached on the inboard and outboard sides of an auxiliary arm which is attached to a slat at a forward end of the arm and ride in an auxiliary track at trailing end of the auxiliary arm. The targets add weight and cost to the detection system.

EP2322431 shows a similar arrangement wherein target strips are attached to each side of the face of each rack. Again the target strips add weight and cost to the arrangement.

An object of the present invention is to provide an improved skew and/or loss detection system.

Thus, according to the present invention there is provided a skew detection system for an aircraft flight control surface, the flight control surface being moveable relative to fixed structure of the aircraft by operation of a first gear rack driven by a first gear pinion and by operation of a second gear rack driven by a second gear pinion,
the skew detection system including a first sensor arrangement and a second sensor arrangement,
the first gear rack having a first set of teeth defining a plurality of first targets, the second gear rack having a second set of teeth defining a plurality of second targets,
the plurality of first targets being configured to move relative to the first sensor arrangement and the plurality of second targets being configured to move relative to the second sensor arrangement,
the skew detection system including a monitoring device to monitor the output from the first and second sensors and determine whether a skew condition has arisen in the flight control surface.

As such it is not necessary to add separate targets since the rack teeth perform the two functions of moving the flight control surface and also acting as targets.

According to an aspect of the present invention there is provided a skew detection system for an aircraft flight control surface, the flight control surface being moveable relative to fixed structure of the aircraft by operation of a first gear rack driven by a first gear pinion and by operation of a second gear rack driven by a second gear pinion,
the skew detection system including a first sensor arrangement and a second sensor arrangement,
the first gear rack having a first set of teeth, the second gear rack having a second set of teeth,
the first gear rack further defining a plurality of first targets integral with the first gear rack, the second gear rack further defining a plurality of second targets integral with the second gear rack,
the plurality of first targets being configured to move relative to the first sensor arrangement and the plurality of second targets being configured to move relative to the second sensor arrangement,
the skew detection system including a monitoring device to monitor the output from the first and second sensors and determine whether a skew condition has arisen in the flight control surface.

As such it is not necessary to add separate targets since the targets are integral with the rack.

The invention will now be described, by way of example only, with reference to the accompanying drawings in which:—

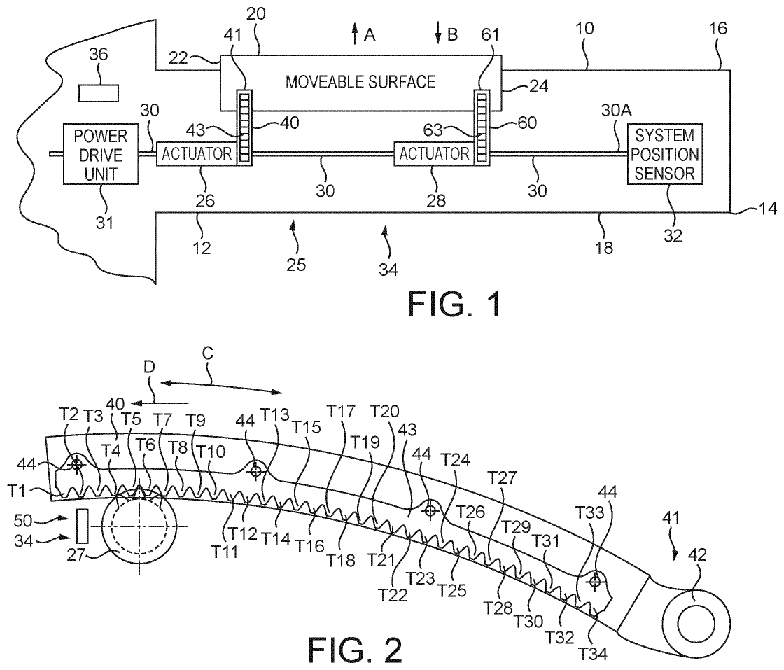

FIG. 1 is a schematic plan view of a skew detection system according to the present invention,

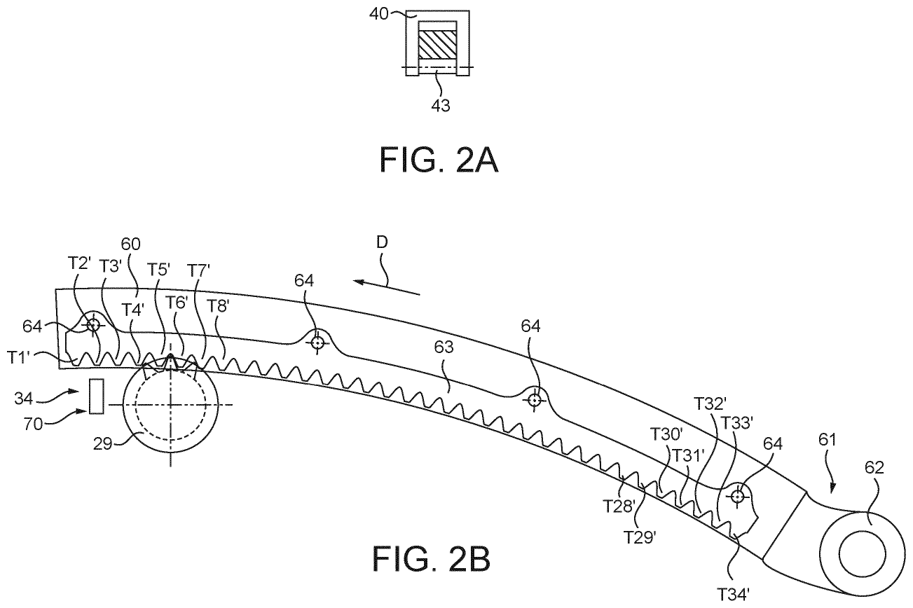

FIG. 2 is a side view of a rack and a sensor arrangement when used with FIG. 1,

FIG. 2A is an end view of FIG. 2,

FIG. 2B is a side view of a rack and a sensor arrangement when used with FIGS. 1 and 2,

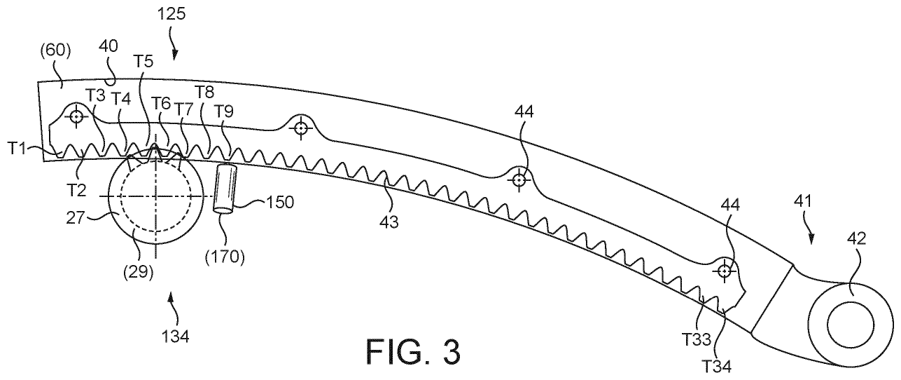

FIG. 3 is a side view of a rack and a sensor arrangement for use with FIG. 1,

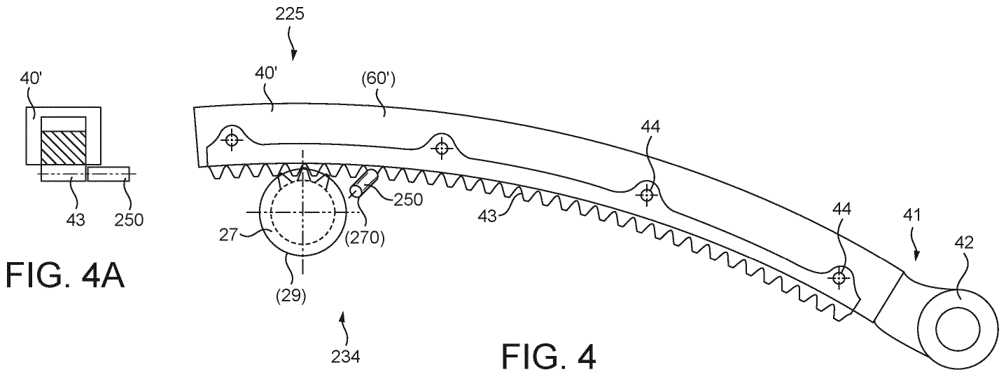

FIG. 4 is a side view of a rack and a sensor arrangement for use with FIG. 1,

FIG. 4A is an end view of FIG. 4,

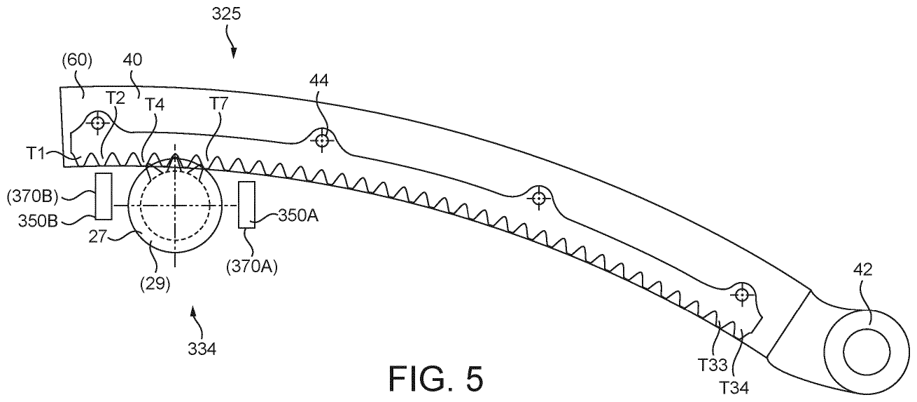

FIG. 5 is a side view of a rack and sensor arrangement for use with FIG. 1,

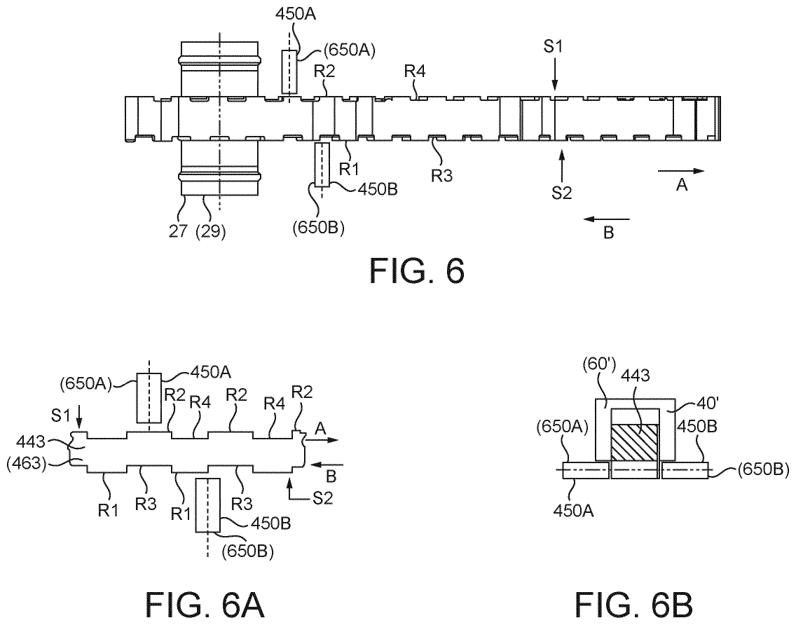

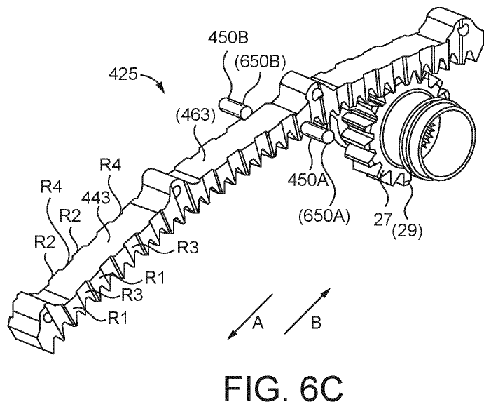

FIG. 6 is a plan view of a rack and sensor arrangement for use with FIG. 1,

FIG. 6A is a developed view of part of FIG. 6,

FIG. 6B is an end view of FIG. 6, and

FIG. 6C is an isometric view of FIG. 6.

With reference to FIG. 1 there is shown an aircraft wing 10 having an inboard (or fuselage) end 12 and an outboard (or wing tip) end 14. The wing has a leading edge 16 and a trailing edge 18. Mounted on the leading edge is a moveable surface 20 e.g. part of a high lift system, for example a slat.

The aircraft also includes a skew detection system 25. The moveable surface 20 has an inboard end 22 and an outboard end 24. Attached near the inboard end 22 is a first track 40. Attached near the outboard end 24 is a second track 60. A first actuator 26 includes a first pinion 27 (see FIG. 2), a second actuator 28 includes a second pinion 29 (see FIG. 2B). Both the first and second actuators 26 and 28 are driven by a common torque shaft system 30. A power drive unit 31, in this case centrally mounted, provides rotational power to drive the torque shaft system 30. A position feedback system is provided via a position sensor 32, in this case located towards the outboard end 14 of the wing 10. In use the power drive unit causes the torque shaft system 30 to selectively rotate thereby driving the actuators which, in turn drive respective pinions 27 and 29. The pinions 27 and 29 engage respective teeth in respective gear sectors 43, 63 (as will be described below) of the first and second tracks 40 and 60. End 41 of first track 40 is connected to the moveable surface 20 and end 61 of the second track 60 is connected to the moveable surface 20.

Operation of the drive unit 31 causing the torque shaft system 30 to rotate in a first direction will cause the actuator 26 and 28 to rotate their associated pinions 27 and 29 in a first direction thereby causing the first track 40 and second track 60 to move in the direction of arrow A resulting in the moveable surface 20 extending. In order to retract the moveable surface 20 the power drive unit 31 causes the torque shaft system 30 to rotate in an opposite direction thereby causing the actuators 26 and 28 to rotate their associated pinions 27 and 29 in an opposite rotational direction thereby causing the first track 40 and second track 60 to move in the direction of arrow B and hence retract the moveable surface 20.

The position sensor 32 monitors the rotational position of end 30A of the torque shaft system 30.

FIG. 2 shows the first track 40 in more detail. The track 40 is U-shaped (see FIG. 2A) in cross-section for efficient bending strength and is attached to the moveable surface 20 via attachment lug 42. A toothed rack 43 (also known as a sector gear) is housed within the track 40, in this case being held within the track by a series of fasteners 44. The toothed rack 43 defines a longitudinal direction, in this case a curved longitudinal direction C. The toothed rack has a set of teeth, in this case 34 teeth in total labelled T1 to T34.

FIG. 2B shows the second track 60 having end 61, attachment lug 62, toothed rack 63 and fasteners 64. Components 60 to 64 are identical to the corresponding components 40 to 44 (though in further embodiments this may not be the case).

FIGS. 1, 2 and 2B show the moveable surface in nearly a fully extended position.

FIGS. 2, 2A and 2B also show a sensor arrangement 34 in the form a first sensor 50 and a second sensor 70. Sensors 50 and 70 are proximity sensors. In the position shown in FIG. 2 first sensor 50 is directed towards the tip of tooth T2. As shown in FIG. 2, sensor 50 can detect the presence of the tip of tooth T2. In the position shown in FIG. 2B the second sensor 70 is directed towards the tip of tooth T2′. As shown in FIG. 2B, sensor 70 can detect the presence of the tip of tooth T2′.

As shown in FIGS. 1, 2 and 2B no skew of moveable surface 20 has occurred. First sensor 50 is capable of detecting the presence of the tip of tooth T2, whilst at the same time, second sensor 70 is capable of detecting the presence of the tip T2′. If it is desired to retract the moveable surface 20 from the FIGS. 2 and 2B position, then the power drive unit 30 will drive actuators 26 and 28 at the same speed which in turn will cause first pinion 27 and second pinion 29 to rotate in an anticlockwise direction at the same speed, therefore causing the first and second tracks 40 and 60 to move in the retraction direction of arrow D at the same speed. Assuming no skew occurs, then during retraction tooth T3 will pass sensor 50 at the same time as tooth T3′ passes sensor 70, tooth T4 will pass sensor 50 at the same time as tooth T4′ passes sensor 70, and so on until the moveable surface 20 is fully retracted whereupon tooth T29 will be sensed by sensor 50 and tooth T29′ will be sensed by sensor 70. When a tooth tip is positioned in line with sensor 50 (e.g. as shown in FIG. 2), then sensor 50 will output a “target near” signal, when there is no tooth opposite sensor 50 (e.g. when the rack has moved such that sensor 50 is opposite a gap between two adjacent teeth), then sensor 50 will output a “target far” signal. Thus, the output signal from sensor 50 when moving from the FIG. 2 position to the fully retracted position will be:—target near, target far, target near, target far, target near etc until tooth T29 is opposite sensor 50 when sensor will output a target near signal. Sensor 70 will equally generate a “target near, target far, target near etc” signal as the moveable surface is retracted from the FIG. 2B position. As will be appreciated, if, during retraction of the moveable surface, no skew occurs then the output signals from sensors 50 and 70 will (for the purposes of ease of explanation) be identical.

However, in the event of skew occurring the output signal from sensors 50 and 70 will no longer be identical. By way of example, assume that starting from the FIG. 2 and FIG. 2B position the power drive unit is operated to retract the moveable surface 20, and assume that whilst the first track 40 is properly driven in a retraction direction, in this instance the second track 60 is assumed to jam in the FIG. 2B position. Under these circumstances sensor 70 will only produce a “target near” signal whereas as soon as the first track 40 starts to move, the output from sensor 50 will change from a target near to a target far signal (as the rack moves to a position where sensor 50 is directed towards the gap between teeth T2 and T3). A monitoring device 36 (see FIG. 1) monitors the output from the first sensor 50 and the second sensor 70 and is configured to determine whether a skew condition has arisen in the moveable surface 20. Upon detection of a skew condition the power drive unit may be shut down and the pilot of the aircraft may be notified of the detection of a skew condition.

As mentioned above, FIGS. 2 and 2B show the moveable surface 20 in a nearly fully extended position. The fully extended position would be when tooth T1 is opposite sensor 50 and tooth T1′ is opposite sensor 70. As will be appreciated, tooth T1 and T2 are never engaged by teeth of pinion 27. Similarly, tooth T1′ and tooth T2′ are never engaged by teeth of pinion 29. Similarly, when the moveable surface 20 is fully retracted tooth T34 will be in the position of tooth T7 as shown in FIG. 2 and as such teeth T30 to T34 are never positioned opposite sensor 50. Thus, certain teeth of tooth rack 43 are never engaged by pinion 27 and certain other teeth of tooth rack 43 are never sensed by sensor 50.

With reference to FIG. 3 there is shown a variant 125 of the skew detection system 25. The variant is the same as shown in FIGS. 2 and 2B except sensors 50 and 70 have been moved from the left hand side of pinions 27 and 29 to the rights hand side of pinions 27 and 29. FIG. 3 shows the first track 40 and its associated pinion 27 and associated first sensor 150. For convenience, also shown on FIG. 3 is second track 60, its associated pinion 29 and its associated second sensor 170 (reference numbers 60, 29 and 170 being shown in brackets).

The consequence of moving the first and second sensors to a position in front of their associated pinion is that the fully extended and fully retracted position of first track 40 and second track 60 of FIG. 3 is now different when compared to FIGS. 2 and 2B.

Thus, in order to move the first track 40 of FIG. 3 to its fully extended position, it must be moved such that tooth T1 shown in FIG. 3 is moved to the position of tooth T4 shown in FIG. 3. In order to fully retract the first track 40 shown in FIG. 3 then tooth T34 must be moved such that it is opposite sensor 150, i.e. moved to the position of tooth T9 as shown in FIG. 3.

As will be appreciated in the embodiments shown in FIG. 3 again, certain teeth do not move past sensor 150 and certain teeth are not engaged by pinion 27, but, in contrast to FIG. 2 it is, for example tooth T33 and T34 that are not engaged by pinion 27 and it is for example tooth T1 and T2 that are not moved past sensor 150, i.e. sensor 150 never detects teeth T1 and T2.

FIGS. 4 and 4A show a variant skew detection system 225. As shown in FIG. 4, first sensor 250 is now in line with, and detects a lateral edge of the teeth of the rack (whereas sensor 150 detected the tips of the teeth). Comparing and contrasting FIG. 4A with FIG. 2A it can be seen that the lower edge of first track 40′ has been removed when compared with track 40 to allow sensor 250 to detect the lateral edges of gear teeth. FIG. 4 shows the first track 40′ and its associated pinion 27 and associated first sensor 250. For convenience, also shown on FIG. 4 is second track 60′, its associated pinion 29 and its associated second sensor 270 (reference numbers 60′, 29 and 270 being shown in brackets).

FIG. 5 shows a variant skew detection system 325. In this case the sensor arrangement 334 includes four sensors, sensors 350A and 350B being associated with rack 40 and sensors 370A and 370B being associated with rack 60. Sensor 350A is positioned on one longitudinal side of pinion 27 (in this case on the leading edge side) and sensor 350B is positioned on the opposite longitudinal side (in this case the trailing edge side) of pinion 27. Similarly sensor 370A is on the leading edge side of pinion 29 and sensor 370B is on the trailing edge side of pinion 29. By providing two sensors, one on each side of the pinion allows for longer travel of the track 40, 60 of FIG. 5 compared to the embodiments shown in FIGS. 2, 2B, 3 and 4. Thus, in a fully extended position tooth T1 will be positioned in place of teeth T4 as shown in FIG. 5. As will be appreciated, tooth T1 and T2 will both have moved beyond sensor 350B.

In the fully retracted position, tooth T34 will be positioned at the position of tooth T7 as shown in FIG. 5. As will be appreciated, tooth T34 will have moved beyond sensor 350A in the fully retracted position. Thus, in the embodiment shown in FIG. 5 in the fully extended position all teeth will have moved beyond sensor 350B, and in the fully retracted position all teeth will have moved beyond sensor 350A. Nevertheless, it will be appreciated, as the track 40 nears its fully extended position, while sensor 350B is unable to detect the final extension movement of the track 40, nevertheless sensor 350A can detect that final extension movement. Equally, as the track 40 nears its fully retracted position, whilst sensor 350A is unable to detect that the final retraction movement, nevertheless sensor 350B can detect such final attraction movement. By providing two sensors, one on each side of the pinion allows for greater extension/retraction movement of the embodiment shown in FIG. 5 when compared with the embodiment shown in FIGS. 2, 2B, 3 and 4. FIG. 3 shows the first track 40 and its associated pinion 27 and associated first sensor 150. For convenience, also shown on FIG. 5 is second track 60, its associated pinion 29 and its associated second sensors 370A and 370B (reference numbers 60, 29, 370A and 370B being shown in brackets).

As mentioned above, for the purposes of the ease of explanation, it has been assumed that during movement of the moveable surface when no skew has occurred then the output signals from sensors 50 and 70 are identical. However, as will be appreciated, due to production tolerances it is not expected that sensors 50 and 70 will switch from “target near” to “target far” (and vice versa) at the same instant. A small transition period will exist where the sensor states will not agree with each other. This momentary disagreement with sensor state can occur without there being an actual slat/skew.

The output from the system position sensor 32 is fed to the monitoring device 36. Thus the monitoring device 36 can determine an expected target near or target far state of sensor 50 and can also determine an expected target near or target far status of sensor 70 in the absence of skew. The monitoring device 36 can also accommodate production tolerances by recognising when sensors 50 and 70 may be within range of transitioning from target near to target far or vice versa. For more details of analysis and recognises that no skew has occurred and how the system recognises that skew has occurred, please refer to U.S. Pat. No. 5,686,907, content of which is hereby incorporated by reference.

With reference to FIGS. 6, 6A, 6B and 6C and there is shown a variant skew detection system 425.

Tooth rack 443 is attached to first track 40′ via fasteners (not shown). In this case the lateral edges of the tooth rack 443 are “castellated” having raised portions R1 on a second side S2 of the rack 443 and raised portions R2 on a first side S1 of the rack 443. Between raised portions R1 there are recessed portions R3. Between raised portions R2 there are recessed portions R4. Sensor 450A is directed towards the first side S1 of the tooth rack 443 and sensor 450B is directed towards the second side S2 of the tooth rack 443.

As best seen in FIG. 6C, the transition between raised portion R1 and adjacent recessed portion R3 occurs in line with the tip of a tooth. Similarly the transition between raised portion R2 and recessed portion R4 also occurs in line with a tip of a tooth.

As best seen in FIG. 6A raised portion R1 on side S2 is in line with recessed portion R4 on side S1. Similarly raised portion R2 on side S1 is in line with recessed portions R3 on side S2.

As best seen in FIG. 6A, sensor 450A is not in line with sensor 450B, rather they are displaced in longitudinal direction relative to each other by 1.5 tooth pitches. Accordingly, as shown in FIG. 6A, sensor 450A is in line with the middle of raised portion R2 whereas sensor 450B is in line with the transition between raised portion R1 and recessed portion R3.

For convenience, also shown on FIG. 4 is the second track 60′ and associated toothed rack 463, sensor 650A, sensor 650B and pinion 29 (reference numbers 60′, 29, 463, 650A and 650B being shown in brackets).

As mentioned above, the skew detection system 425 is used in conjunction with the components in FIG. 1 though in this example it is not necessary to include a system position sensor 32.

FIGS. 6, 6A and 6C show the extension direction A, i.e. the direction in which the toothed racks 443 and 463 move when the moveable surface 20 is being extended. FIGS. 6, 6A and 6B also show the retraction direction B, i.e. the direction in which the toothed racks 443 and 463 move when the moveable surface 20 is being retracted.

In use, the output of one of the sensors 450A and 450B associated with rack 443 is used in conjunction with the output of one of the other sensors 650A and 650B associated with the other rack 463 to provide a first channel to sense the occurrence of a skew condition. The output of the other sensor associated with rack 443 is used in conjunction with the output of the other sensor associated with the rack 463 to form a second sensing channel. It will be appreciated that in this manner a degree of redundancy is provided within the system to ensure that the occurrence of a skew condition can still be detected in the event of failure, of for example, one of the sensors. As shown in FIG. 6A, the output from sensor 450A is used in conjunction with the output from sensor 650B to form a first channel. The output from sensor 650A is used in conjunction with the output from sensor 450B to form a second sensing channel.

The two channels operate in substantially the same manner and so only operation of the first channel will be described hereinafter in detail.

In use, during movement of the moveable surface 20 in an extension direction A first pinion 27 and second pinion 29 will be driven in an anticlockwise direction when viewing FIG. 6C by the power drive unit 31. Upon sensing that the output of one of the sensors 450A and 650B is in a transition state, i.e. changing from target near to target far, or changing from target far to target near, the monitoring device 36 determines whether the transition state is a rising transition state, i.e. transition from target far to target near, or a falling transition state, i.e. transitioning from target near to target far. The nature of transition state is used to determine whether the output of the other sensor 450A, 650B is expected to be target near or target far. For example, consider the scenario where the moveable surface 20 is being extended and the toothed racks 443 and 463 are moving in the direction of arrow A and have just reached the position shown in FIG. 6A. Under these circumstances sensor 650B is transitioning from target far to target near. The expected output of sensor 450A (i.e. assuming no skew) is therefore target near. Further movement in the extension direction A of the toothed racks 443 and 463 will cause sensor 450A to transition from target near to target far, where upon the output signal from sensor 650 B is expected to be target near assuming no skew has occurred between racks 443 and 463.

Clearly, if the racks 443 and 463 are moving in a retraction direct B, then, as best seen in FIG. 6A, the transition states are reversed, in this case as sensor 650B transitions from target near to target far then the output signal from sensor 450A would be target near. As will be appreciated, the direction in which racks 443 and 463 are moving are determined by the direction of rotation of the power drive unit 31.

As will be appreciated, in the event of skew occurring then as one of sensors 450A or 650B transitions between target near and target far, then the output signal from the other of sensors 450A and 650B will not be as expected. By way of example, assume that starting from the FIG. 6A position the power drive unit is operated to extend the moveable surface 20, and assume that whilst tooth rack 463 moves in the extension direction A, tooth rack 443 remains in the position shown in FIG. 6A. Under these circumstances after movement of the rack by 1 pitch tooth distance, as sensor 650B transitions from target near to target far, sensor 450A would be expected to output a target far signal, whereas since tooth rack 443 has jammed, sensor 450A will continue to output a target near signal, thereby indicating skew has occurred.

For more details of how skew and the absence of skew is detected, please refer to European patent EP2322413, the content of which is hereby incorporated by reference.

As described above, the power drive unit moves a single moveable surface 20 on each side of the aircraft. In further embodiments the torque shaft system 30 may drive a plurality of moveable surfaces on each side of the aircraft and the system position sensor 32 may be positioned outboard of the plurality of moveable surfaces. As described above, the moveable surface may be a slat on the leading edge. In further embodiments the moveable surface may be any moveable surface of the aircraft including moveable surfaces on the trailing edge of a wing such as flaps.

As described above, tracks 40, 60, 40′ and 60′ are all U-shaped, though further embodiments any shape of track could be used. As described above the toothed racks 43, 63, 443 and 463 are all arcuate, though in further embodiments the racks need not be arcuate.

As described above, as shown in FIGS. 2, 2B, 3 and 4 a single sensor is associated with each rack. For redundancy purposes further sensors could be used directed towards each rack. As described above, moveable surface 20 has two identical racks, though in further embodiments the inboard and outboard racks need not be the same. As described above each of the racks shown in FIG. 1 has an identical sensor arrangement, though in further embodiments this need not be the case. Thus, one rack of FIG. 1 could include the sensor arrangement of any one of FIG. 2, 3, 4 or 5 and the other rack of FIG. 1 could include a sensor arrangement of any one of FIG. 2, 3, 4 or 5.

As described above, failure mode has been described as jamming of one or other of the racks. The present skew detection system is capable of identifying skew however that skew is caused.

With regard to FIGS. 6 to 6C, the first set of targets and second set of targets are integral with the gear rack itself. In this example they are castellations formed on the gear rack, though in further embodiments other shapes could be formed integrally on the gear rack. As best seen in FIG. 6C the transition of the raised portions and recess portions occurs in line with a tooth tip. In further embodiments a translation between a raised and lowered portion need not be in line with the tip of the tooth. The pitch of any formations need not be the same as the pitch of the teeth. As shown in FIG. 6B the sensors 450A, 450B, 650A and 650B are all directed towards the teeth of the rack, though in further embodiments the feature used to provide a “target near” and “target far” signal need not be on the teeth of the rack, and as such sensor need not be directed towards the teeth of the rack.

As described above, the sensors are all proximity sensors, though any type of sensor could be used such as optical sensors, mechanical switches etc.

As described above, the castellations on racks 443 and 4463 are all integral. In this example the castellations are formed of the same material as the associated racks. In further embodiments other integral feature could be formed on the same material as the rack, for example a series of holes could be drilled in the material of the rack.

As described above with respect to FIG. 6A, the sensor 450A and 650B are spaced apart by 1.5 tooth pitches. In further embodiments they could be spaced apart by a different amount and/or the raised and lowered portions on side S1 could be offset longitudinally relative to the raised or lowered portions on side S2.

1. A skew detection system for an aircraft flight control surface, the flight control surface being moveable relative to fixed structure of the aircraft by operation of a first gear rack driven by a first gear pinion and by operation of a second gear rack driven by a second gear pinion,
the skew detection system including a first sensor arrangement and a second sensor arrangement,
the first gear rack having a first set of teeth defining a plurality of first targets, the second gear rack having a second set of teeth defining a plurality of second targets,
the plurality of first targets being configured to move relative to the first sensor arrangement and the plurality of second targets being configured to move relative to the second sensor arrangement,
the skew detection system including a monitoring device to monitor the output from the first and second sensors and determine whether a skew condition has arisen in the flight control surface.

2. A skew detection system as defined in claim 1 wherein the plurality of first targets are defined by tips of the teeth of the first set of teeth and/or the plurality of second targets are defined by tips of the teeth of the second set of teeth.

3. A skew detection system as defined in claim 1 wherein the plurality of first targets is defined by a lateral edge of the teeth of the first set of teeth and/or the plurality of second targets are defined by a lateral edge of the teeth of the second set of teeth.

4. A skew detection system as defined in claim 1 wherein the first sensor arrangement is positioned proximate the first gear pinion and/or the second sensor arrangement is positioned proximate the second gear pinion.

5. A skew detection system as defined in claim 1 wherein the first rack defines a longitudinal direction and the first sensor arrangement is defined by a primary first sensor and a secondary first sensor, the primary first sensor being positioned on one longitudinal side of the first pinion and the secondary first sensor being positioned on an opposite longitudinal side of the first pinion,
the plurality of first targets being configured to move beyond one of the primary first sensor and secondary first sensor.

6. A skew detection system for an aircraft flight control surface, the flight control surface being moveable relative to fixed structure of the aircraft by operation of a first gear rack driven by a first gear pinion and by operation of a second gear rack driven by a second gear pinion,
the skew detection system including a first sensor arrangement and a second sensor arrangement,
the first gear rack having a first set of teeth, the second gear rack having a second set of teeth,
the first gear rack further defining a plurality of first targets integral with the first gear rack, the second gear rack further defining a plurality of second targets integral with the second gear rack,
the plurality of first targets being configured to move relative to the first sensor arrangement and the plurality of second targets being configured to move relative to the second sensor arrangement,
the skew detection system including a monitoring device to monitor the output from the first and second sensors and determine whether a skew condition has arisen in the flight control surface.

7. A skew detection system as defined in claim 6 wherein the plurality of first targets is defined by a lateral edge of the first gear rack and/or the plurality of second targets are defined by a lateral edge of the second gear rack.

8. A skew detection system as defined in claim 6 wherein the first sensor arrangement is positioned proximate the first gear pinion and/or the second sensor arrangement is positioned proximate the second gear pinion.

9. A skew detection system as defined in claim 1 including a position sensor to monitor the movement of the first gear pinion and second gear pinion.

10. A skew detection system as defined in claim 1 wherein the monitoring device is operable upon sensing that an output of a first one of the sensors is in a transition state, to determine, from a transition direction of the transition state, and an output of the other of the sensors whether a skew condition has arisen.

11. A skew detection system as defined in claim 6 including a position sensor to monitor the movement of the first gear pinion and second gear pinion

12. A skew detection system as defined in claim 6 wherein the monitoring device is operable upon sensing that an output of a first one of the sensors is in a transition state, to determine, from a transition direction of the transition state, and an output of the other of the sensors whether a skew condition has arisen.
